(19) United States
(12) Patent Application Publication
(10) Pub. No.: US 2016/0187625 A1
(43) Pub. Date: Jun. 30, 2016

(54) VIS-INFRARED CORRECTIV FISHEYE LENS SYSTEM FOR EXTREME TEMPERATURES

(71) Applicant: Sheng-Feng Lin, Taichung City (TW)

(72) Inventor: Sheng-Feng Lin, Taichung City (TW)

(21) Appl. No.: 14/586,864

(22) Filed: Dec. 30, 2014

(51) Int. Cl. G02B 13/06; G02B 9/60; G02B 13/18; G02B 13/14

(52) U.S. Cl. CPC G02B 13/06; G02B 13/146; G02B 9/60; G02B 13/18

(57) ABSTRACT

An vis-infrared corrective fisheye lens system is provided with, from upstream to downstream, a first lens of negative meniscus, a second lens of biconcave, a third lens of biconvex, an aperture, a fourth lens of biconvex, a fifth lens of negative meniscus, a sixth lens of biconvex, an exchangeable optical filter, and an imaging plane. The lens system has an ultra wide angle of about 210-degree and is capable of operating in a temperature range of −15° C.-80° C. so that the lens system can be mounted in a surveillance system in a vehicle or an outdoor place.

### BACKGROUND OF THE INVENTION

1. Field of the Invention

The invention relates to fixed focus fisheye lens systems and more particularly to a vis-infrared corrective fisheye lens system including six lenses, an aperture, an exchangeable optical filter, and an imaging plane, the vis-infrared corrective fisheye lens system having an ultra wide angle of about 210-degree and adapted to operate in a temperature range of −15° C.-80° C. so that the lens system can be mounted in a surveillance system, in a vehicle or an outdoor place.

2. Description of Related Art

We can find surveillance cameras installed in homes, vehicles, etc. as technologies advance. Typically, a surveillance camera, for indoors, outdoors, or vehicle applications, has a limited field of view (FOV) of about 140-degree. Thus, there are areas not covered by the surveillance camera in use. Further, the typical surveillance cameras are appropriate for operation in a temperature range of 0° C.-50° C. not for environments having temperature not in the range (i.e., in extreme temperatures).

Thus, the need for improvement still exists.

### SUMMARY OF THE INVENTION

It is therefore one object of the invention to provide a vis-infrared corrective fisheye lens system comprising a first lens of negative meniscus having a convex surface toward the object plane; a second biconcave lens nearby paraxial optical axis disposed downstream of the first lens and having a concave surface nearby paraxial optical axis toward the first lens; a third lens of biconvex disposed downstream of the second lens and having a convex surface toward the first lens; an aperture disposed downstream of the third lens; a fourth lens of biconvex disposed downstream of the aperture and having a convex surface toward the first lens; a fifth lens of negative meniscus disposed downstream of the fourth lens and having a concave surface toward the first lens; a sixth lens of biconvex lens nearby paraxial optical axis disposed downstream of the fifth lens and having a convex surface nearby paraxial optical axis toward the first lens; an exchangeable optical filter disposed downstream of the sixth lens; and an imaging plane disposed downstream of the exchangeable optical filter.

The above and other objects, features and advantages of the invention will become apparent from the following detailed description taken with the accompanying drawings.

### BRIEF DESCRIPTION OF THE DRAWINGS

FIG. 1 schematically depicts in section of locations of all lenses of a fixed focus fisheye lens system according to the invention;

FIG. 2A plots astigmatic field curves versus focus for Sagittal plane in wide angle of view;

FIG. 2B plots astigmatic field curves versus focus for Meridional plane in wide angle of view;

FIG. 2C plots a curve of distortion in % versus field angle;

FIG. 3 plots lateral color versus field angle for short-long wave length curve and short-reference wave length curve in lateral color simulation. Lateral color represents different magnification differences of chromatic aberration generated by images of RGB color model;

FIG. 4 is a relative illumination (RI) plot for plotting relative illumination versus field angle for RI curve, cos ̂4 curve and 50% curve;

FIG. 5 plots modulation transfer function (MTF) versus cumulative probability for tolerance analysis curves at 25° C.;

FIG. 6A plots spatial frequency versus diffraction MTF at −15° C.;

FIG. 6B plots defocusing position versus MTF for frequency 50 cycles/mm at −15° C.;

FIG. 7A plots spatial frequency versus diffraction MTF at 40° C.;

FIG. 7B plots defocusing position versus MTF for frequency 50 cycles/mm at 40° C.;

FIG. 8A plots spatial frequency versus diffraction MTF at 80° C.; and

FIG. 8B plots defocusing position versus MTF for frequency 50 cycles/mm at 80° C.

### DETAILED DESCRIPTION OF THE INVENTION

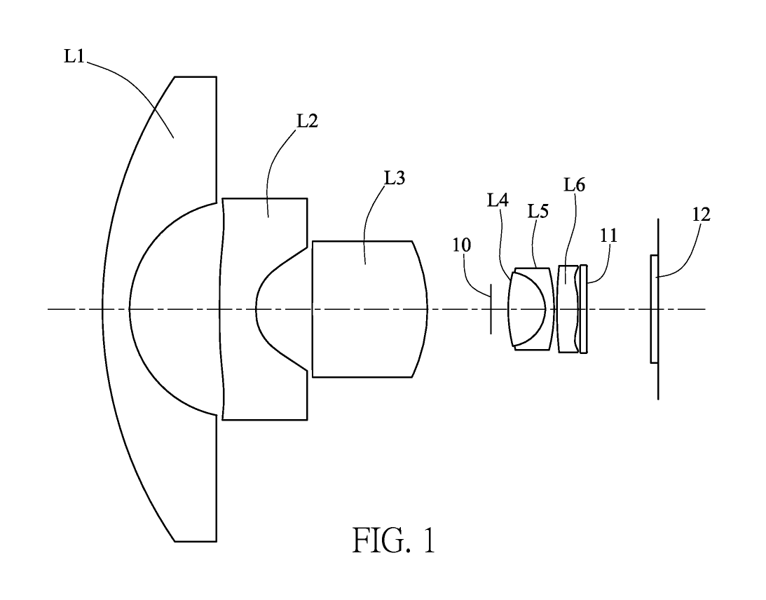

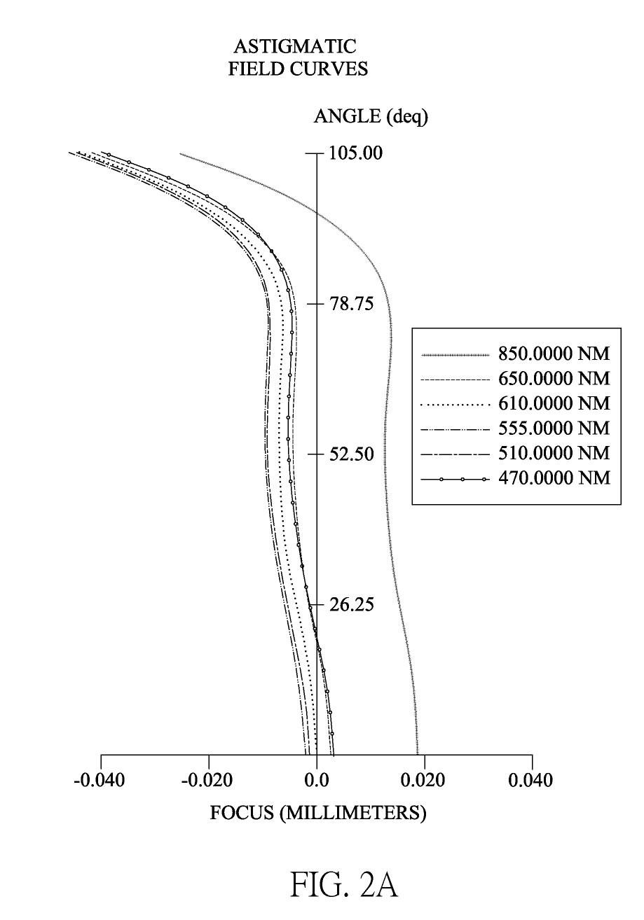

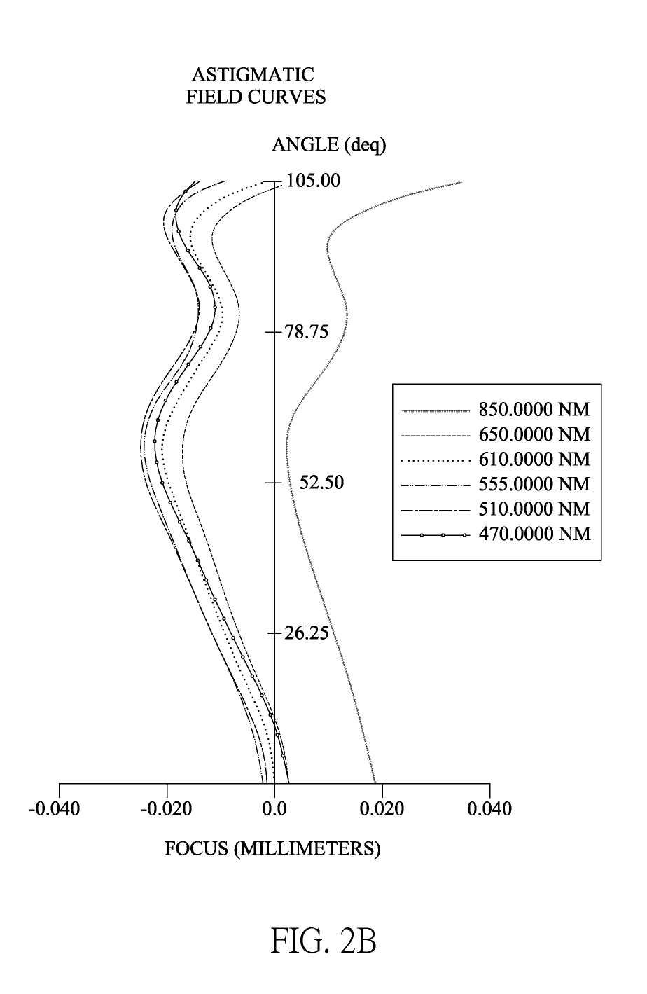

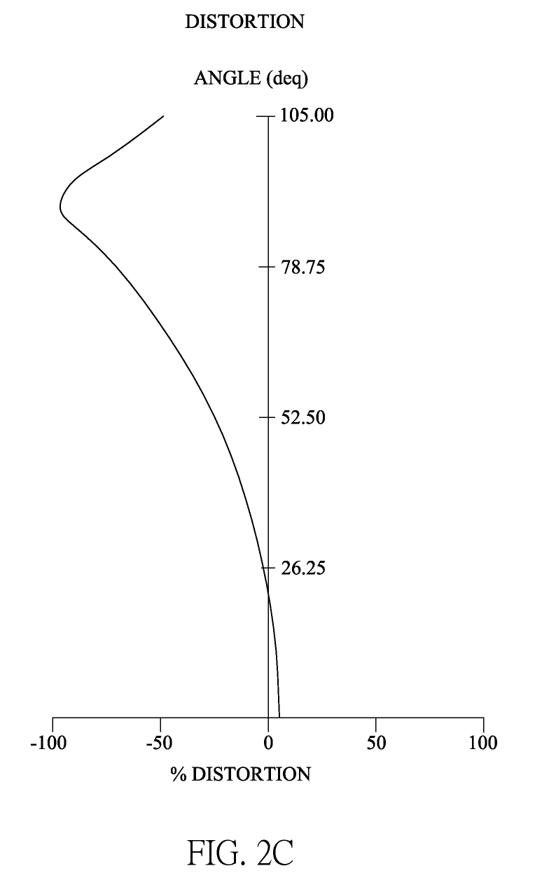

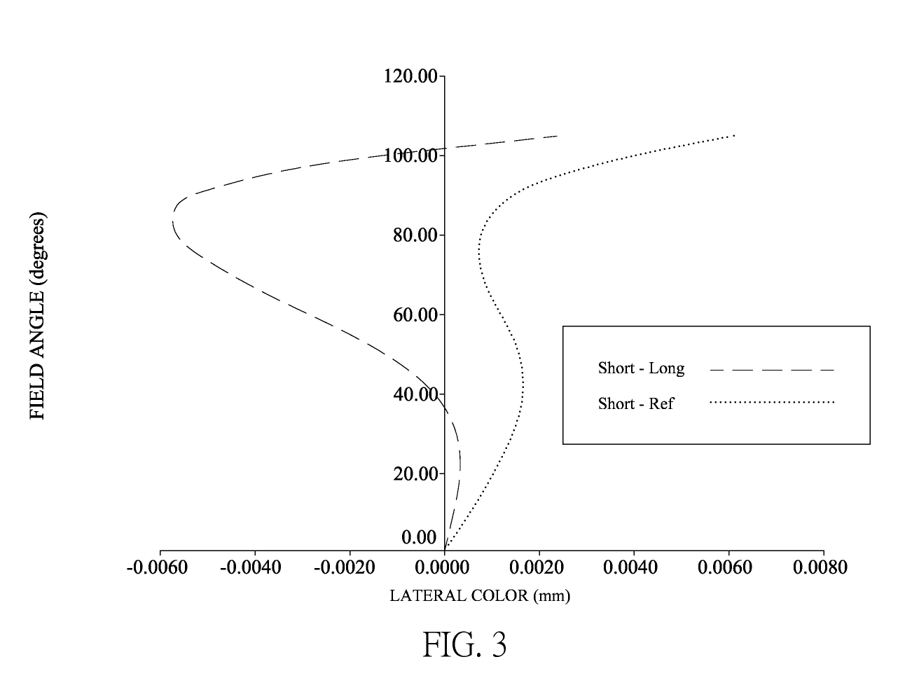

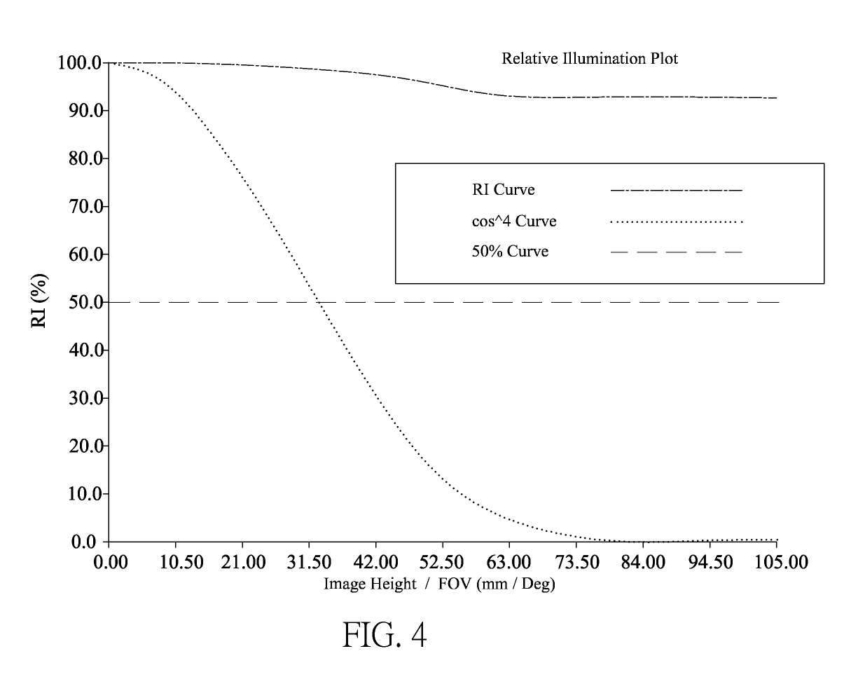

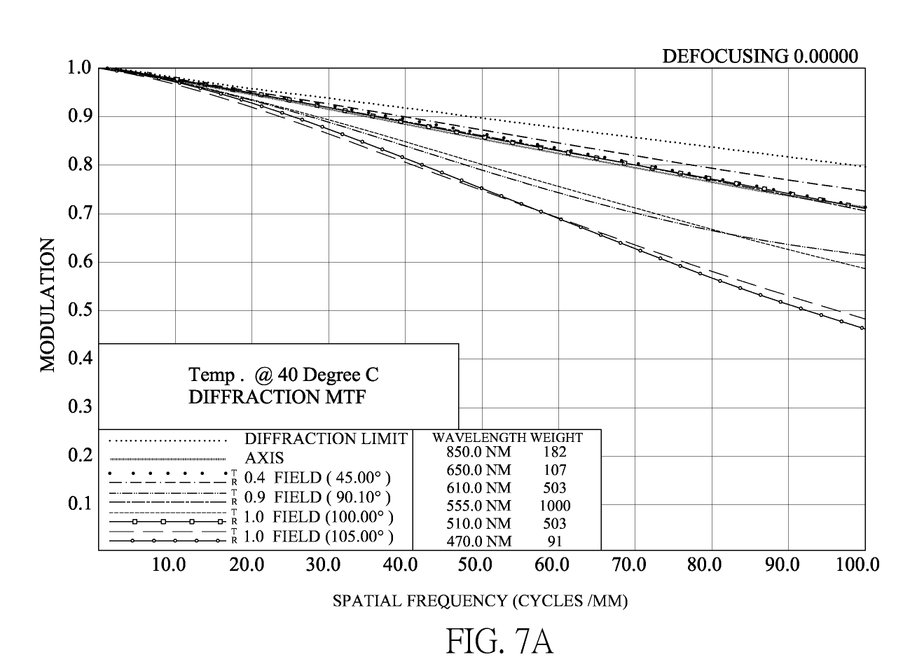

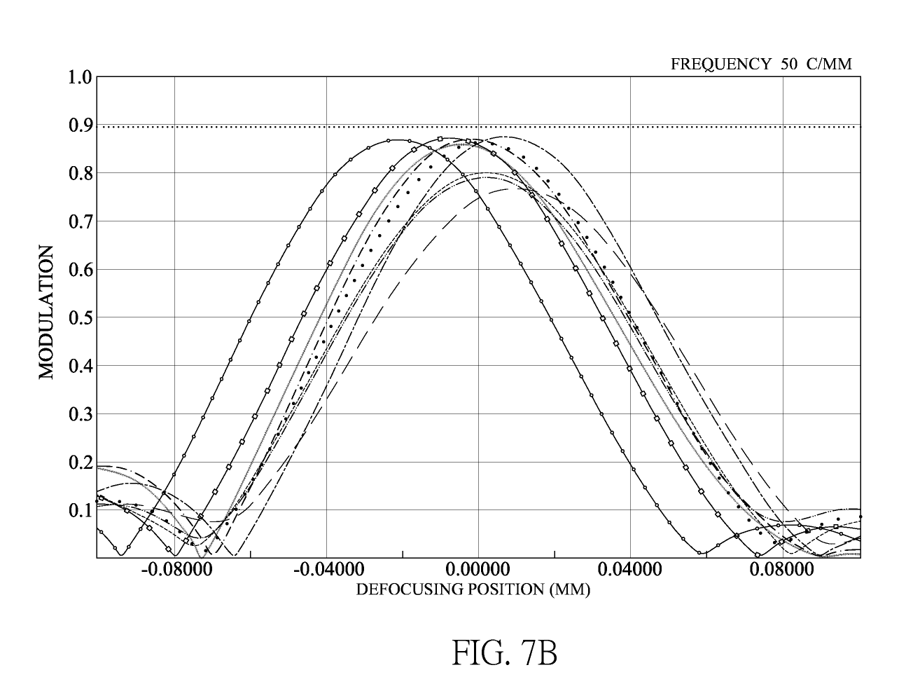

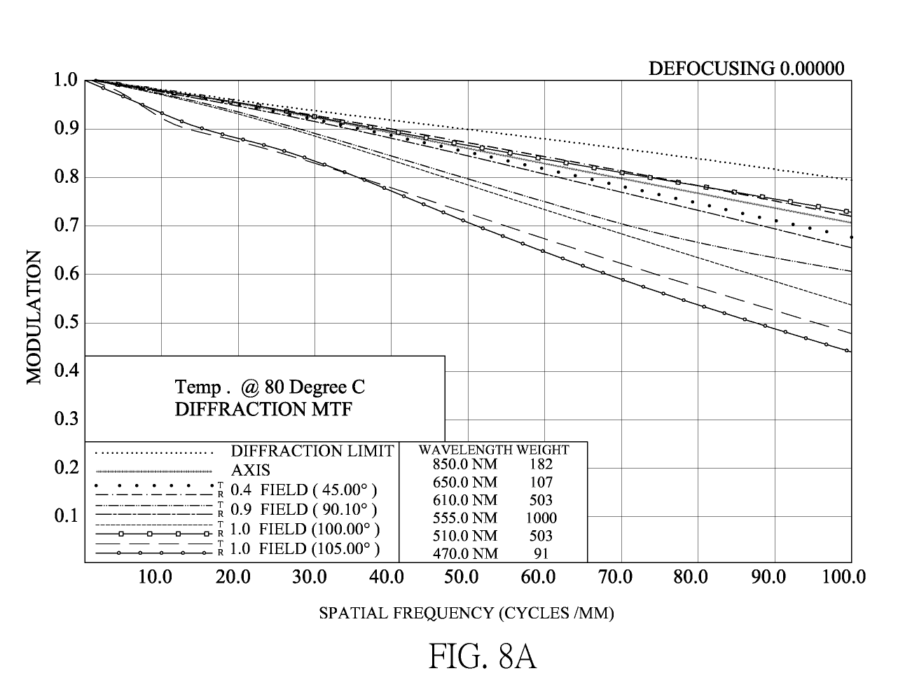

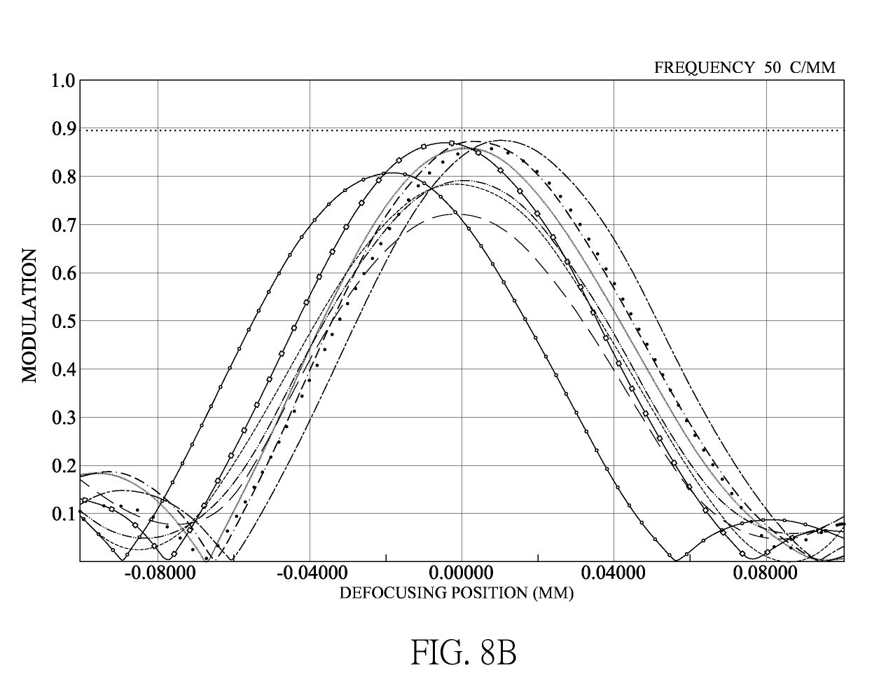

Referring to FIGS. 1 to 8B, a fixed focus fisheye lens system in accordance with the invention is shown. The fixed focus fisheye lens system is implemented as a vis-infrared corrective fisheye lens system for operating at extreme temperatures and comprises, from the lens surface toward an object plane (not shown) to the lens proximate an imaging plane 12, a first lens L1 of negative meniscus, a second biconcave lens L2 nearby paraxial optical axis, a third lens L3 of biconvex, an aperture 10, a fourth lens L4 of biconvex, a negative meniscus L5, a biconvex L6 nearby paraxial optical axis, an exchangeable optical filter 11, and an imaging plane 12.

The lens system is configured to have an ultra wide angle of about 210-degree and operate in a temperature range of −15° C.-80° C. so that the above lenses must have the following characteristics:

The first lens L1 is required to satisfy the following conditions: 1.82<nd1<1.85, where nd1 is refractive index of the first lens L1; 40<vd1<45, where vd1 is abbe number of the first lens L1; 22 mm<R11<22.5 mm, where R11 is radius of curvature of the convex surface of the first lens L1 toward the object plane; 5.5 mm<R12<6.5 mm, where R12 is radius of curvature of the concave surface toward the imaging plane 12; and 1.4 mm<t1<1.6 mm, where t1 is center thickness of the first lens L1.

The second lens L2 is required to satisfy the following conditions: 1.5<nd2<1.55, where nd2 is refractive index of the second lens L2; 55<vd2<58, where vd2 is abbe number of the second lens L2; −23.5 mm<R21<−22.5 mm, where R21 is paraxial radius of curvature of the concave surface of the second lens L2 toward the object plane; 2.5 mm<R22<2.7 mm, where R22 is paraxial radius of curvature of the concave surface of the second lens L2 toward the imaging plane 12; and 1.8 mm<t2<2.2 mm, where t2 is center thickness of the second lens L2.

The third lens L3 is required to satisfy the following conditions: 1.83<nd3<1.86, where nd3 is refractive index of the third lens L3; 23<vd3<25, where vd3 is abbe number of the third lens L3; 660 mm<R31<665 mm, where R31 is radius of curvature of the convex surface of the third lens L3 toward the object plane; −9 mm<R32<−8.5 mm, where R32 is radius of curvature of the convex surface of the third lens L3 toward the imaging plane 12; and 6.3 mm<t3<6.5 mm, where t3 is center thickness of the third lens L3.

The fourth lens L4 is required to satisfy the following conditions: 1.7<nd4<1.8, where nd4 is refractive index of the fourth lens L4; 45<vd4<55, where vd4 is abbe number of the fourth lens L4; 7.6 mm<R41<7.8 mm, where R41 is radius of curvature of the convex surface of the fourth lens L4 toward the object plane; −2.2 mm<R42<−2 mm, where R42 is radius of curvature of the convex surface of the fourth lens L4 toward the imaging plane 12; and 2 mm<t4<2.2 mm, where t4 is center thickness of the fourth lens L4.

The fifth lens L5 is required to satisfy the following conditions: 1.83<nd5<1.86, where nd5 is refractive index of the fifth lens L5; 23<vd5<25, where vd5 is abbe number of the fifth lens L5; −2.2 mm<R51<−2 mm, where R51 is radius of curvature of the concave surface of the fifth lens L5 toward the object plane; −11.5 mm<R52<−11 mm, where R52 is radius of curvature of the convex surface of the fifth lens L5 toward the imaging plane 12; and 0.4 mm<t5<0.6 mm, where t5 is center thickness of the fifth lens L5.

The sixth lens L6 is required to satisfy the following conditions: 1.5<nd6<1.55, where nd6 is refractive index of the sixth lens L6; 55<vd6<58, where vd6 is abbe number of the sixth lens L6; −25.7 mm<R61<−25.3 mm, where R61 is paraxial radius of curvature of the convex surface of the sixth lens L6 toward the object plane; −6.4 mm<R62<−6 mm, where R62 is paraxial radius of curvature of the convex surface of the sixth lens L6 toward the imaging plane 12; and 1.0 mm<t6<1.3 mm, where t6 is center thickness of the sixth lens L6.

The exchangeable optical filter 11 is required to satisfy the following conditions: 1.5<nd7<1.54, where nd7 is refractive index of the exchangeable optical filter 11; 60<vd7<68, where vd7 is abbe number of the exchangeable optical filter 11; and 0.2 mm<t7<0.4 mm, where t7 is thickness of the exchangeable optical filter 11. The exchangeable optical filter 11 can replaced with a different one when wavelength is changed in a different application.

Preferably, the fourth lens L4 and the fifth lens L5 are cemented doublet lens.

Preferably, an optical path from the convex surface of the first lens L1 toward the imaging plane 12 is between 30 mm and 31 mm.

Preferably, the lens system can operate in a temperature range of −15° C.-80° C.

Preferably, an optical image having a wavelength in the range of 470 nm to 850 nm can be formed on the imaging plane 12.

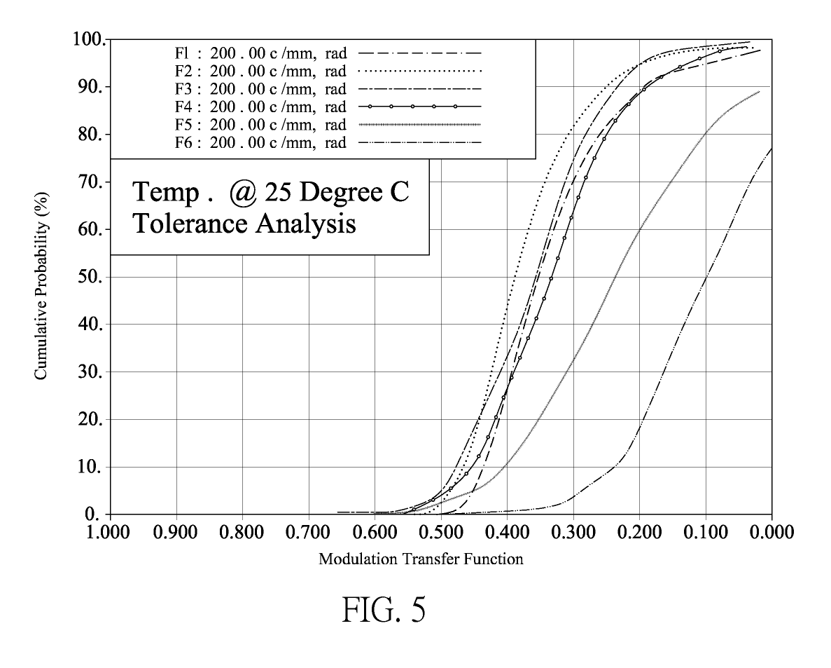

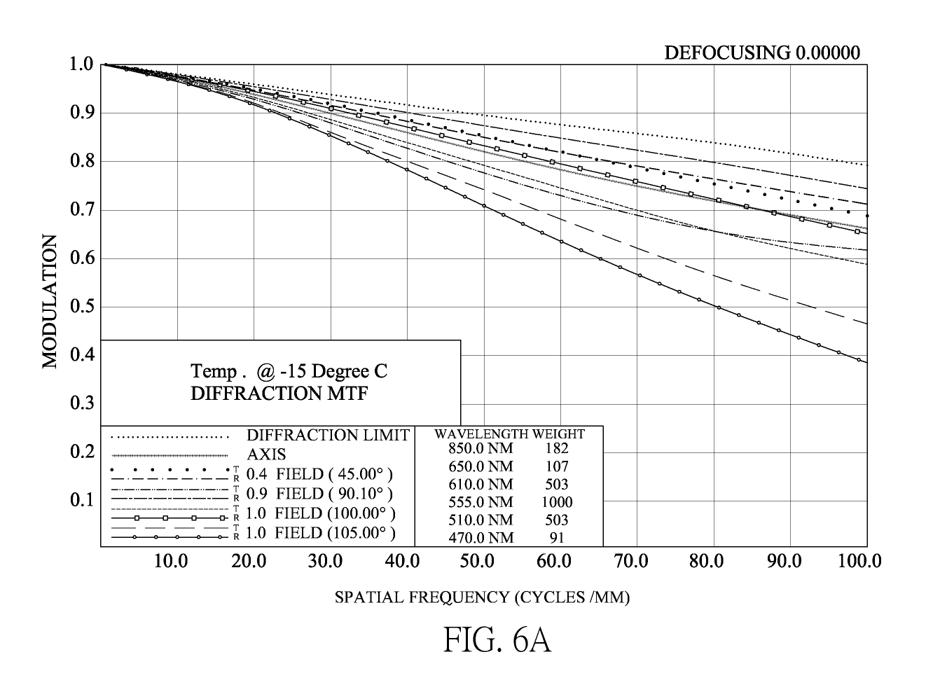

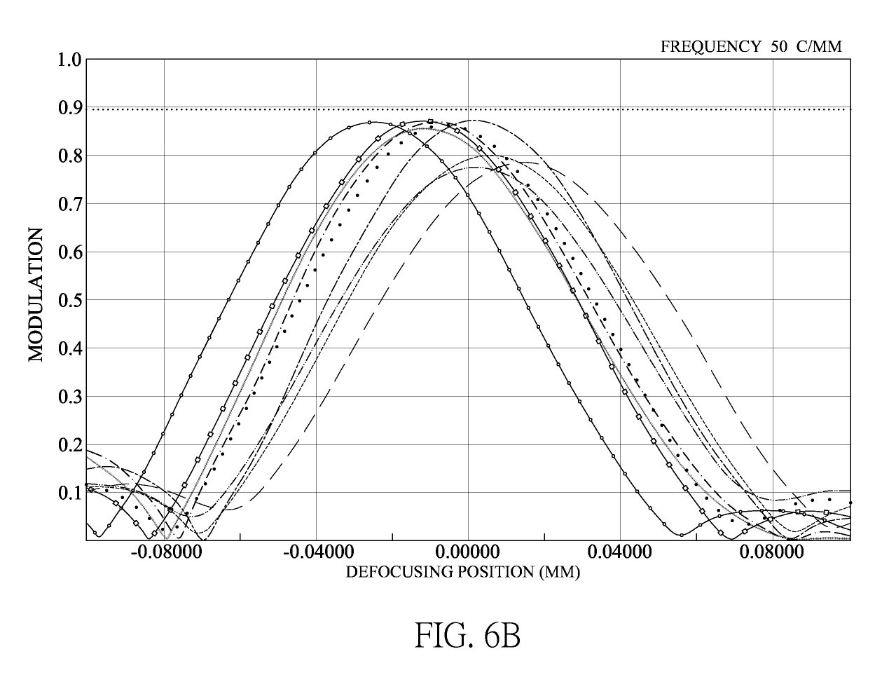

Regarding tolerance analysis in FIG. 5, it is a cumulative probability for tolerance analysis. Since no perfect lens, mechanical elements and manufacturing parameters can be built perfectly in optical system. Tolerance analysis results can predict the results of yield after build through the statistics distribution of the analyzed results via defining the limits of the fabrication errors. Regarding modulation transfer function (MTF) and focal length at different temperatures shown in FIGS. 6A-8B, the MTF is the transfer function of an optical system such as a camera or any imaging system. It is used to describe how the optics ray trace from the object or scene onto a photographic film, detector array, screen or simply the next item in the transmission chain. The function specifies the translation and contrast reduction of a periodic sine pattern after passing through the lens system, as a function of its periodicity and orientation. While figures of merit such as contrast, sensitivity, and resolution give an intuitive indication of performance, the MTF provides a comprehensive and well-defined characterization of optical systems.

While the invention has been described in terms of preferred embodiments, those skilled in the art will recognize that the invention can be practiced with modifications within the spirit and scope of the appended claims.

What is claimed is:

1. A vis-infrared corrective fisheye lens system comprising:
a first lens of negative meniscus having a convex surface toward the object plane;
a second biconcave lens nearby paraxial optical axis disposed downstream of the first lens and having a concave surface toward the first lens;
a third lens of biconvex disposed downstream of the second lens and having a convex surface toward the first lens;
an aperture disposed downstream of the third lens;
a fourth lens of biconvex disposed downstream of the aperture and having a convex surface toward the first lens;
a fifth lens of negative meniscus disposed downstream of the fourth lens and having a concave surface toward the first lens;
a sixth lens of biconvex lens nearby paraxial optical axis disposed downstream of the fifth lens and having a convex surface toward the first lens;
an exchangeable optical filter disposed downstream of the sixth lens; and
an imaging plane disposed downstream of the exchangeable optical filter.

2. The vis-infrared corrective fisheye lens system of claim 1, wherein the first lens satisfies: 1.82<nd1<1.85, where nd1 is refractive index of the first lens; 40<vd1<45, where vd1 is abbe number of the first lens; 22 mm<R11<22.5 mm, where R11 is radius of curvature of a convex surface of the first lens; 5.5 mm<R12<6.5 mm, where R12 is radius of curvature of the concave surface of the first lens toward the imaging plane; and 1.4 mm<t1<1.6 mm, where t1 is center thickness of the first lens.

3. The vis-infrared corrective fisheye lens system of claim 1, wherein the second lens satisfies: 1.5<nd2<1.55, where nd2 is refractive index of the second lens; 55<vd2<58, where vd2 is abbe number of the second lens; −23.5 mm<R21<−22.5 mm, where R21 is paraxial radius of curvature of the concave surface of the second lens toward the first lens; 2.5 mm<R22<2.7 mm, where R22 is paraxial radius of curvature of the concave surface of the second lens toward the imaging plane; and 1.8 mm<t2<2.2 mm, where t2 is center thickness of the second lens.

4. The vis-infrared corrective fisheye lens system of claim 1, wherein the third lens satisfies: 1.83<nd3<1.86, where nd3 is refractive index of the third lens; 23<vd3<25, where vd3 is abbe number of the third lens; 660 mm<R31<665 mm, where R31 is radius of curvature of the convex surface of the third lens toward the first lens; −9 mm<R32<−8.5 mm, where R32 is radius of curvature of the convex surface of the third lens toward the imaging plane; and 6.3 mm<t3<6.5 mm, where t3 is center thickness of the third lens.

5. The vis-infrared corrective fisheye lens system of claim 1, wherein the fourth lens satisfies: 1.7<nd4<1.8, where nd4 is refractive index of the fourth lens; 45<vd4<55, where vd4 is abbe number of the fourth lens; 7.6 mm<R41<7.8 mm, where R41 is radius of curvature of the convex surface of the fourth lens toward the first lens; −2.2 mm<R42<−2 mm, where R42 is radius of curvature of the convex surface of the fourth lens toward the imaging plane; and 2 mm<t4<2.2 mm, where t4 is center thickness of the fourth lens.

6. The vis-infrared corrective fisheye lens system of claim 1, wherein the fifth lens satisfies: 1.83<nd5<1.86, where nd5 is refractive index of the fifth lens; 23<vd5<25, where vd5 is abbe number of the fifth lens; −2.2 mm<R51<−2 mm, where R51 is radius of curvature of the concave surface of the fifth lens L5 toward the first lens; −11.5 mm<R52<−11 mm, where R52 is radius of curvature of the convex surface of the fifth lens toward the imaging plane; and 0.4 mm<t5<0.6 mm, where t5 is center thickness of the fifth lens.

7. The vis-infrared corrective fisheye lens system of claim 1, wherein the sixth lens satisfies: 1.5<nd6<1.55, where nd6 is refractive index of the sixth lens; 55<vd6<58, where vd6 is abbe number of the sixth lens; −25.7 mm<R61<−25.3 mm, where R61 is paraxial radius of curvature of the convex surface of the sixth lens toward the first lens; −6.4 mm<R62<−6 mm, where R62 is paraxial radius of curvature of the convex surface of the sixth lens toward the imaging plane; and 1.0 mm<t6<1.3 mm, where t6 is center thickness of the sixth lens.

8. The vis-infrared corrective fisheye lens system of claim 1, wherein the exchangeable optical filter satisfies: 1.5<nd7<1.54, where nd7 is refractive index of the exchangeable optical filter; 60<vd7<68, where vd7 is abbe number of the exchangeable optical filter; and 0.2 mm<t7<0.4 mm, where t7 is thickness of the exchangeable optical filter.

9. The vis-infrared corrective fisheye lens system of claim 5, wherein the fourth lens and the fifth lens are cemented doublet lens.

10. The vis-infrared corrective fisheye lens system of claim 6, wherein the fourth lens and the fifth lens are cemented doublet lens.

11. The vis-infrared corrective fisheye lens system of claim 1, wherein an optical path from the convex surface of the first lens to the imaging plane is between 30 mm and 31 mm.

12. The vis-infrared corrective fisheye lens system of claim 1, wherein the lens system has an ultra wide angle of about 210-degree, is capable of operating in a temperature ranged between −15° C. to −80° C., and an optical image having a wavelength in ranged between 470 nm to 850 nm is formed on the imaging plane.

13. The vis-infrared corrective fisheye lens system of claim 1, wherein the lenses satisfy the following data:

| | | radius of | cneter | refrac- | abbe |
|---|---|---|---|---|---|
| | surface | curvature | thickness | tive | num- |
| lens | shape | (mm) | (mm) | index | ber |
| L1 | sphere | 22.215 | 1.48 | 1.83481 | 42.73 |
| | sphere | 5.92 | 4.97 | | |
| L2 | aspherical | −22.964 | 2 | 1.52512 | 56.2815 |
| | aspherical | 2.615 | 2.85 | | |
| L3 | sphere | 662.96 | 6.4 | 1.846663 | 23.78 |
| | sphere | −8.77 | 3.73 | | |
| STOP | | ∞ | 0.72 | | |
| L4 | sphere | 7.697 | 2.07 | 1.743305 | 49.24 |
| L5 | sphere | −2.1 | 0.5 | 1.846663 | 23.78 |
| | sphere | −11.343 | 0.15 | | |
| L6 | aspherical | −25.486 | 1.18 | 1.52512 | 56.2815 |
| | aspherical | −6.2 | 0.15 | | |
| exchangeable | plane | ∞ | 0.3 | 1.5168 | 64.17 |
| optical filter | plane | ∞ | 3.6 | | |
| cover glass | plane | ∞ | 0.4 | 1.566 | 55 |
| protector of | plane | ∞ | 0 | | |
| image sensor | | | | | |
| imaging plane | plane | ∞ | 0 | | |

14. The vis-infrared corrective fisheye lens system of claim 13, wherein effective focal length (EFL) is 1.32 mm at −15° C., EFL is 1.34 mm at 80° C., focal length to aperture diameter ratio (F/#) is 2.8, total track (TT) is 30.5 mm, image height (h) is 4.86 mm at −15° C., h is 4.95 mm at 80° C., TT/f is 23.1 at −15° C., and TT/f is 22.75 at 80° C.

15. The vis-infrared corrective fisheye lens system of claim 14, wherein the lenses satisfies the following data: h(θ)=M×f×θ, 0.975≦M≦0.985, 1.32 mm≦EFL≦1.35 mm, 30 mm≦TT≦31 mm, and FOV≦210-degree.
